(19) United States
(12) Patent Application Publication
(10) Pub. No.: US 2006/0176260 A1
(43) Pub. Date: Aug. 10, 2006

(54) Burn-in prevention circuit, projector, liquid crystal display apparatus, and burn-in prevention method

(75) Inventor: Fumio Koyama, Shiojiri-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 10/640,402

(22) Filed: Aug. 14, 2003

(30) Foreign Application Priority Data
Oct. 10, 2002 (JP) 2002-297398

(51) Int. Cl. G09G 3/36

(52) U.S. Cl. 345/89

(57) ABSTRACT

A tone correction LUT 310 reads an offset Vos1 corresponding to a tone level of a digital image signal Vi and outputs the offset Vos1 to an adder-subtracter circuit 320. The adder-subtracter circuit 320 adds the offset Vos1 to the digital image signal Vi according to the polarity of a polarity specification signal INV and outputs a digital image signal Vs1. An in-plane correction arithmetic circuit 330 reads an offset Vos2 corresponding to a display position or a pixel position in response to a positioning signal POS and outputs the offset Vos2 to an adder-subtracter circuit 340. The adder-subtracter circuit 340 adds the offset Vos2 to the digital image signal Vs1 according to the polarity of the polarity specification signal INV and outputs a digital image signal Vs2. A DA converter 350 with AC actuation functions converts the digital image signal Vs2 into an analog image signal Vo, and carries out polarity inversion at each frame scanning period according to the polarity of the polarity specification signal INV, so as to output a signal allowing for AC actuation of liquid crystal. This arrangement effectively prevents a burn-in of an image plane in a liquid crystal display apparatus equipped with liquid crystal panels.

### BACKGROUND OF THE INVENTION

1. Field of the Invention

The present invention relates to a technique of preventing a burn-in of an image plane in a liquid crystal display apparatus equipped with liquid crystal panels, for example, a liquid crystal projector.

2. Description of the Related Art

Liquid crystal panels have been used widely as electro-optic devices for image formation. The liquid crystal panel applies a voltage onto liquid crystal of each pixel, in response to a pixel signal corresponding to the pixel, and regulates the transmittance of the light, with which the pixel is irradiated, so as to form an image.

FIGS. 5(A) and 5(B) show an equivalent circuit to one arbitrary pixel in a liquid crystal panel and the waveform of a voltage applied to the arbitrary pixel. As shown in FIG. 5(A), one pixel PE is provided via a switching element TFT (thin film transistor) 142 at an intersection of a scanning line SL and a signal line DL crossing to each other. A gate electrode of the switching element TFT (hereafter referred to as ‘TFT switch’) 142 is connected to the scanning line SL, a drain electrode is connected to the signal line DL, and a source electrode is connected to a pixel electrode 144 in the pixel PE. An opposed electrode 146 opposed to the pixel electrode 144 is connected to an opposed electrode signal line LCCOM. The opposed electrode 146 is generally formed as a common electrode to all the pixels.

Liquid crystal is located between the pixel electrode 144 and the opposed electrode 146. This liquid crystal is equivalent to a capacity CLC (hereafter referred to as ‘liquid crystal capacity’). A storage capacity Cs is added in parallel to the liquid crystal capacity CLC. A composite capacity Cpe (=CLC·Cs/(CLC+Cs)) of the liquid crystal capacity CLC and the storage capacity Cs is called ‘pixel capacity’.

In an image signal Vo supplied through the signal line DL, a pixel signal Vop corresponding to the pixel PE is written into the pixel capacity Cpe via the TFT switch 142, which is under on-off control with a switch voltage Vg of a scanning line driving signal supplied through the scanning line SL. More specifically, as shown in FIG. 5(B), the pixel signal Vop is written as a pixel electrode voltage Vp into the pixel capacity Cpe in a sampling period Ts, and the pixel electrode voltage Vp is kept in a hold period Th. The potential difference between the pixel electrode voltage Vp applied to the pixel electrode 144 and an opposed electrode voltage Vcom applied to the opposed electrode 146 actuates the liquid crystal on the pixel electrode 144. The liquid crystal is actuated in this manner in other multiple pixels arranged in a matrix.

Application of a direct current (DC) voltage to the liquid crystal for a long time period causes polarization of impurity ions inside the liquid crystal to change the physical properties of the material and decrease the resistivity. A burn-in of an image plane, that is, a remaining trace of a displayed image, arises as a typical example of such deterioration phenomena.

One prior art technique to solve the burn-in problem is alternating current actuation of each pixel (that is, liquid crystal). As shown in FIG. 5(B), the technique carries out polarity inversion of the pixel electrode voltage Vp applied to the pixel electrode 144 relative to the opposed electrode voltage Vcom applied to the opposed electrode 146, for example, at each frame scanning period. This alternating current actuation sets the mean voltage applied between the pixel electrode 144 and the opposed electrode 146 equal to 0 V and prevents a DC voltage from being applied to the liquid crystal. The polarity inversion generally means alternate shifting of the voltage level to a positive electrode level and to a negative electrode level across the level 0. In the specification hereof, however, the polarity inversion is not restricted to the alternate shifting across the level 0, but includes alternate shifting of the voltage level to a higher level and to a lower level across a preset level. For convenience of explanation, the higher level and the lower level may respectively be called the positive electrode and the negative electrode.

In the actual operations, however, the alternating current actuation may not be attained to set the mean voltage applied to each pixel PE equal to 0 V, because of the reason discussed below.

An optimum value of the opposed electrode voltage Vom, which sets the mean voltage applied to each pixel PE equal to 0 V, varies with a variation in magnitude of the pixel electrode voltage Vp applied to the pixel electrode 144, that is, with a variation in tone level of the image signal. This is ascribed to the fact that the direction and the quantity of a leakage current in the block-off state of the TFT switch 142 depends upon the polarity and the tone of the pixel signal Vop, which may be higher or lower than the opposed electrode voltage Vcom. The optimum value of the opposed electrode voltage Vcom also has a difference among individual TFTs. This results in a variation in optimum value of the opposed electrode voltage Vcom in the image plane of the liquid crystal panel.

Even when the opposed electrode voltage Vcom is set to an optimum value at a pixel for black display, the setting of the opposed electrode voltage Vcom is deviated from an optimum value at a pixel for white display. The mean voltage applied to the pixel for white display is thus not set equal to 0 V, but an effective DC voltage is applied. This causes a burn-in of the image plane. Such a problem also arises when the opposed electrode voltage Vcom is set to an optimum value at a pixel for white display or at a pixel for display of an intermediate tone, instead of at the pixel for black display.

This problem is not restricted to the case of varying the tone level of the image signal, but also arises in the case of varying the display position or pixel position in the image plane of the liquid crystal panel.

The optimum value of the opposed electrode voltage Vcom, which sets the mean voltage applied to each pixel PE equal to 0 V, also varies with a variation in pixel position in the image plane of the liquid crystal panel. For example, the opposed electrode voltage Vcom is set to have an optimum value at a pixel located in a center area of the image plane. This setting of the opposed electrode voltage Vcom is, however, deviated from an optimum value at a pixel located in a peripheral area of the image plane. The mean voltage applied to the pixel located in the peripheral area is accordingly not set equal to 0 V, and an effective DC voltage is applied. This results in a burn-in of the image plane. Such a problem also arises when the opposed electrode voltage Vcom is set to have an optimum value at a pixel located at any arbitrary position, instead of the pixel located in the center area of the image plane.

The burn-in of the image plane becomes more noticeable with the size reduction of the liquid crystal display apparatus and with the enhanced luminance and the increased resolution of a displayed image. The size reduction and the enhanced luminance of the projector heighten the luminous flux density and increase the leakage current.

### SUMMARY OF THE INVENTION

The object of the present invention is thus to solve the drawbacks of the prior art techniques and to provide a technique of effectively preventing a burn-in of an image plane in a liquid crystal display apparatus equipped with liquid crystal panels.

In order to attain at least part of the above and the other related objects, the present invention is directed to a first burn-in prevention circuit that prevents a burn-in of an image plane on a liquid crystal panel. The first burn-in prevention circuit includes: an offset output module that outputs an offset varying with a variation in tone level of an image signal; an offset adjunction module that adds at least the offset to the image signal; and an alternating current actuation conversion module that converts the image signal with the offset added thereto into a specific image signal, which allows for alternating current actuation of liquid crystal at a predetermined cycle. The specific image signal is supplied to the liquid crystal panel. The offset corresponds to a difference between an optimum value of an opposed electrode voltage and an actual value of the opposed electrode voltage at a tone level of the image signal in the liquid crystal panel.

In the first burn-in prevention circuit of the present invention, the offset output module outputs the offset varying with a variation in tone level of the image signal. The offset adjunction module adds the offset to the image signal. The alternating current actuation conversion module converts the image signal with the offset added thereto into the specific image signal that allows for alternating current actuation of liquid crystal at a predetermined cycle. The specific image signal is supplied to the liquid crystal panel.

Even when the actual value of the opposed electrode voltage is deviated from the optimum value at a certain tone level of the image signal in the liquid crystal panel, the offset corresponding to the deviation, that is, the difference between the optimum value and the actual value of the opposed electrode voltage at the certain tone level, is added to the image signal, which is to be supplied to the liquid crystal panel. The pixel electrode voltage applied to the pixel electrode of the liquid crystal panel accordingly includes the offset. The voltage actually applied to the pixel is equivalent to application of the original pixel electrode voltage without the offset to the pixel electrode and application of the optimum value as the opposed electrode voltage. The mean voltage actually applied to the pixel is thus set equal to 0 V, and no DC voltage is applied. This arrangement effectively prevents a burn-in of the image plane.

The invention is also directed to a second burn-in prevention circuit that prevents a burn-in of an image plane on a liquid crystal panel. The second burn-in prevention circuit includes: an offset output module that outputs an offset varying with a variation in display position or pixel position in an image plane of the liquid crystal panel; an offset adjunction module that adds at least the offset to the image signal; and an alternating current actuation conversion module that converts the image signal with the offset added thereto into a specific image signal, which allows for alternating current actuation of liquid crystal at a predetermined cycle. The specific image signal is supplied to the liquid crystal panel. The offset corresponds to a difference between an optimum value of an opposed electrode voltage and an actual value of the opposed electrode voltage at a pixel position in the image plane of the liquid crystal panel.

In the second burn-in prevention circuit of the present invention, the offset output module outputs the offset varying with a variation in display position or pixel position in the image plane. The offset adjunction module adds the offset to the image signal. The alternating current actuation conversion module converts the image signal with the offset added thereto into the specific image signal that allows for alternating current actuation of liquid crystal at a predetermined cycle. The specific image signal is supplied to the liquid crystal panel.

Even when the actual value of the opposed electrode voltage is deviated from the optimum value at a certain display position or pixel position in the image plane of the liquid crystal panel, the offset corresponding to the deviation, that is, the difference between the optimum value and the actual value of the opposed electrode voltage at the certain display position or pixel position, is added to the image signal, which is to be supplied to the liquid crystal panel. The pixel electrode voltage applied to the pixel electrode of the liquid crystal panel accordingly includes the offset. The voltage actually applied to the pixel is equivalent to application of the original pixel electrode voltage without the offset to the pixel electrode and application of the optimum value as the opposed electrode voltage. The mean voltage actually applied to the pixel is thus set equal to 0 V, and no DC voltage is applied. This arrangement effectively prevents a burn-in of the image plane.

In one preferable application of the burn-in prevention circuit of the present invention, the offset output from the offset output module and the image signal, to which the offset is added by the offset adjunction module, are both digital signals.

The arrangement of adding the digital signal to the digital signal ensures accurate addition of the offset to the image signal.

In one preferable embodiment of the burn-in prevention circuit of the invention, the offset output module includes a memory.

The use of a lookup table enables the simple circuit structure to output the offset corresponding to the tone level or the pixel position.

In another preferable embodiment of the burn-in prevention circuit of the invention, the alternating current actuation conversion module has a digital-to-analog conversion module that converts a digital image signal into an analog image signal.

The digital-to-analog conversion module included in the alternating current actuation conversion module desirably decreases the total number of parts and reduces the required circuit size.

The present invention is further directed to a third burn-in prevention circuit that prevents a burn-in of an image plane on a liquid crystal panel. The third burn-in prevention circuit includes: an offset adjunction module that adds a predetermined offset to an image signal; and an alternating current actuation conversion module that converts an image signal into a signal, which allows for alternating current actuation of liquid crystal at a predetermined cycle. A resulting image signal, which includes the offset added thereto and has been converted to allow for the alternating current actuation, is supplied to the liquid crystal panel. The offset includes at least one of a first offset corresponding to a difference between an optimum value of an opposed electrode voltage, which varies with a variation in tone level of the image signal in the liquid crystal panel, and an actual value of the opposed electrode voltage, and a second offset corresponding to a difference between an optimum value of the opposed electrode voltage, which varies with a variation in display position or pixel position in the image plane of the liquid crystal panel, and an actual value of the opposed electrode voltage.

In the third burn-in prevention circuit of the present invention, the offset adjunction module adds a predetermined offset to the image signal. The alternating current actuation conversion module converts the image signal into the signal allowing for alternating current actuation of liquid crystal at a predetermined cycle. The resulting image signal, which includes the offset added thereto and has been converted to allow for the alternating current actuation, is supplied to the liquid crystal panel.

The third burn-in prevention circuit may carry out the conversion of the image signal to allow for the alternating current actuation after addition of the offset to the image signal, or may alternatively add the offset to the image signal after the conversion of the image signal to allow for the alternating current actuation.

The offset includes at least one of the first offset and the second offset. Even when the actual value of the opposed electrode voltage is deviated from the optimum value at a certain tone level of the image signal in the liquid crystal panel, the offset including the first offset is added to the pixel electrode voltage applied to the pixel electrode of the liquid crystal panel. Even when the actual value of the opposed electrode voltage is deviated from the optimum value at a certain display position or pixel position in the image plane of the liquid crystal panel, the offset including the second offset is added to the pixel electrode voltage applied to the pixel electrode of the liquid crystal panel. In either case, the voltage actually applied to the pixel is equivalent to application of the original pixel electrode voltage without the offset to the pixel electrode and application of the optimum value as the opposed electrode voltage. The mean voltage actually applied to the pixel is thus set equal to 0 V, and no DC voltage is applied. This arrangement effectively prevents a burn-in of the image plane.

The invention is not restricted to the burn-in prevention circuits discussed above. The technique of the present invention may be actualized by other applications, for example, a projector or a liquid crystal display apparatus including the burn-in prevention circuit of any of the above arrangements and a method of preventing a burn-in of the image plane in the liquid crystal panel.

These and other objects, features, aspects, and advantages of the present invention will become more apparent from the following detailed description of the preferred embodiment with the accompanying drawings.

### BRIEF DESCRIPTION OF THE DRAWINGS

FIG. 1 is a block diagram showing the general structure of a liquid crystal projector including burn-in prevention circuits in one embodiment of the present invention;

FIG. 2 is a block diagram showing the structure of each signal processing system included in the liquid crystal projector of FIG. 1;

FIGS. 3(A) and 3(B) show the burn-in prevention principle of the present invention;

FIGS. 4(A) through 4(H) are timing charts showing variations of essential signals in the burn-in prevention circuit of FIG. 2;

FIGS. 5(A) and 5(B) show an equivalent circuit to one arbitrary pixel in a liquid crystal panel and the waveform of a voltage applied to the arbitrary pixel.

### DESCRIPTION OF THE PREFERRED EMBODIMENTS

One mode of carrying out the invention is discussed below as a preferred embodiment in the following sequence:

A. Structure and Operations of Signal Processing System

B. Burn-in Prevention Principle

C. Structure and Operations of Burn-in Prevention Circuit

D. Method of Detecting Optimum Value of Opposed Electrode Voltage

E. Modifications

A. Structure and Operations of Signal Processing System

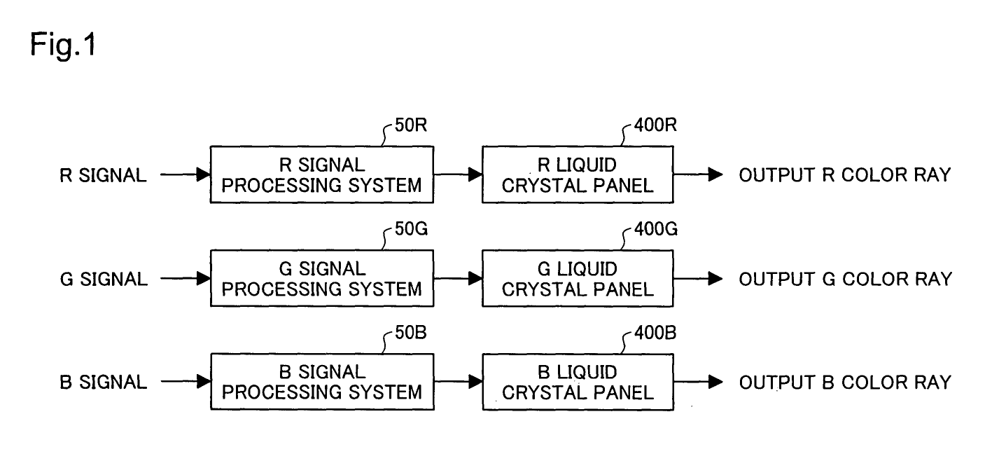

FIG. 1 is a block diagram showing the general structure of a liquid crystal projector including burn-in prevention circuits in one embodiment of the present invention. The liquid crystal projector includes three liquid crystal panels respectively corresponding to three colors R (red), G (green), and B (blue), a liquid crystal panel for the color R (hereafter referred to as R liquid crystal panel) 400R, a liquid crystal panel for the color G (hereafter referred to as G liquid crystal panel) 400G, and a liquid crystal panel for the color B (hereafter referred to as B liquid crystal panel) 400B. The liquid crystal projector also has three signal processing systems corresponding to the three colors R, G, and B to process image signals, a signal processing system for the color R (hereafter referred to as R signal processing system) 50R, a signal processing system for the color G (hereafter referred to as G signal processing system) 50G, and a signal processing system for the color B (hereafter referred to as B signal processing system) 50B.

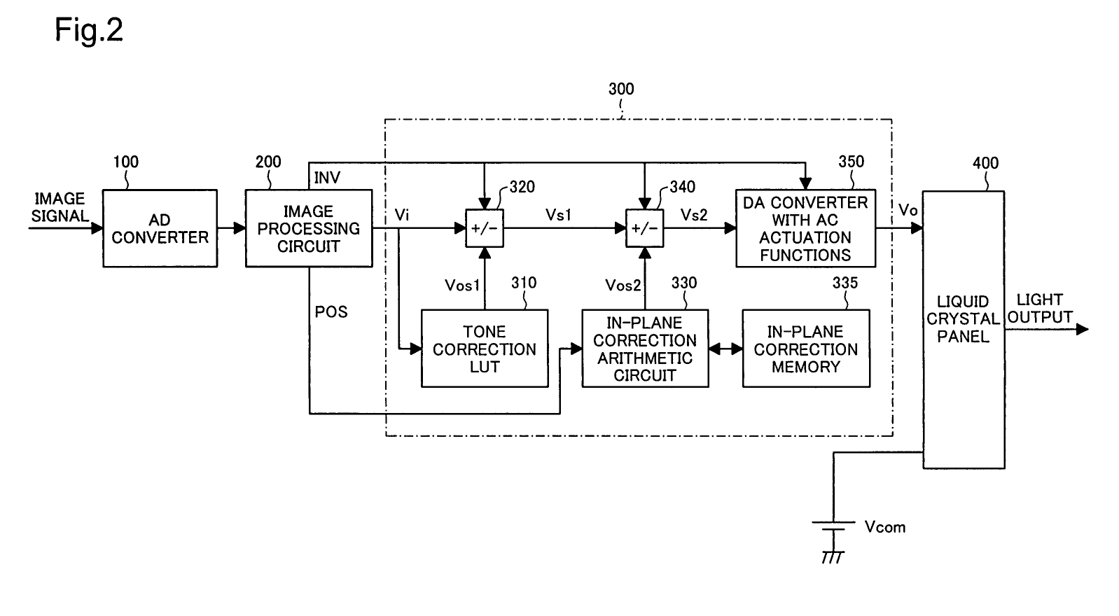

FIG. 2 is a block diagram showing the structure of each signal processing system included in the liquid crystal projector of FIG. 1. The three signal processing systems, that is, the R signal processing system 50R, the G signal processing system 50G, and the B signal processing system 50B have a substantially identical structure. The structure shown in FIG. 2 is thus applicable to any of these three signal processing systems.

Each of the signal processing systems 50R, 50G, and 50B includes an AD converter 100, an image processing circuit 200, and a burn-in prevention circuit 300 of the embodiment, and is connected to the corresponding liquid crystal panel 400.

R, G, and B analog image signals transmitted from outside to the liquid crystal projector are input into the corresponding signal processing systems. The AD converter 100 converts the input analog image signals into digital image signals. When the input image signal is a composite signal, another circuit element takes charge of demodulating the composite signal and separating R, G, and B signals from a synchronizing signal in the demodulated composite signal.

The image processing circuit 200 writes the converted digital image signals into a built-in frame memory (not shown) in response to system clocks, and reads the digital image signals written in the frame memory in response to display clocks. The image processing circuit 200 carries out diverse series of required processing, for example, conversion of a frame rate or a resizing process, in the course of the writing and reading operations. The image processing circuit 200 also executes sharpness processing and gamma correction.

The burn-in prevention circuit 300 receives a processed digital image signal Vi, makes the digital image signal Vi subjected to a burn-in prevention process (discussed later) and digital-to-analog conversion, and outputs a resulting analog image signal Vo to the liquid crystal panel 400, so as to actuate the liquid crystal panel 400.

Illumination light emitted from a lighting optical system (not shown) is divided into color rays R, G, and B, which enter the respective R, G, and B liquid crystal panels 400R, 400G, and 400B. Each of the liquid crystal panels 400 modulates the incident illumination light according to the input analog image signal Vo. The R, G, and B color rays of the illumination light modulated by the respective liquid crystal panels 400R, 400G, and 400B are mixed and are projected on a screen (not shown) by means of a projection optical system (not shown). A resulting color image is then displayed on the screen.

As mentioned above, the liquid crystal projector has the three signal processing systems respectively corresponding to the colors R, G, and B, that is, the R signal processing system 50R, the G signal processing system 50G, and the B signal processing system 50B. Part of the circuit structures may be shared by the three colors R, G, and B.

B. Burn-in Prevention Principle

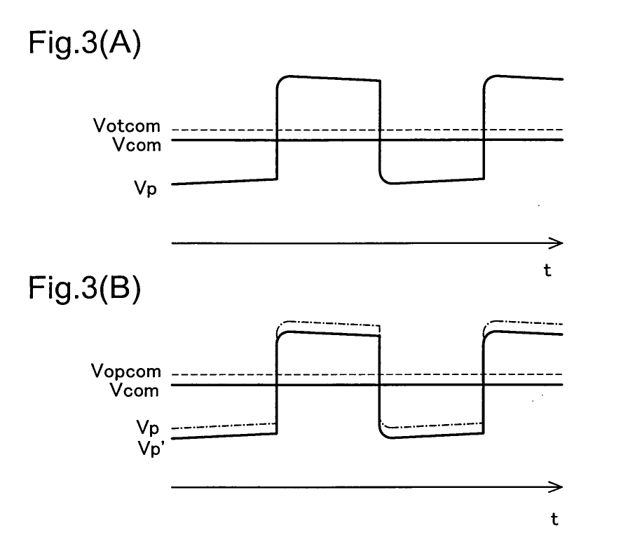

FIGS. 3(A) and 3(B) show the burn-in prevention principle of the present invention. Each graph shows the waveforms of voltages applied to one arbitrary pixel in the liquid crystal panel, that is, the waveform of a pixel electrode voltage Vp applied to a pixel electrode 144 and the waveform of an opposed electrode voltage Vcom applied to an opposed electrode 146. The graph of FIG. 3(A) shows the results without any burn-in prevention process, and the graph of FIG. 3(B) shows the results with the burn-in prevention process of the present invention.

An optimum value of the opposed electrode voltage to set a mean voltage actually applied to the pixel equal to 0 V depends upon the magnitude of the pixel electrode voltage applied to the pixel electrode 144, that is, the tone level of the pixel signal, and upon the display position on the image plane of the liquid crystal panel, that is, the pixel position.

Here it is assumed that the optimum value of the opposed electrode voltage is Votcom and the actual value of the opposed electrode voltage is Vcom, when the pixel signal has a certain tone level or when the pixel position is at a certain position on the image plane. The actual value of the opposed electrode voltage is deviated from the optimum value. The mean voltage actually applied to the pixel is accordingly not set equal to 0 V, but an effective DC offset is applied. This results in a burn-in of the image plane.

In order to prevent such a burn-in, the opposed electrode voltage should be varied to continuously follow the varying optimum value. The opposed electrode voltage Vcom is, however, common to all the pixels and is fixed to a certain direct current (DC) voltage. Namely the opposed electrode voltage can not be varied according to the tone level or the pixel position.

The procedure of the invention specifies, as an offset, a difference ΔVcom between the optimum value Votcom and the actual value (the fixed DC voltage) Vcom of the opposed electrode voltage and practically adds the specified offset to the pixel electrode voltage Vp, as shown in FIG. 3(B). This corrects the pixel electrode voltage Vp to a corrected pixel electrode voltage Vp′, which is applied to the pixel electrode 144.

The voltage V actually applied to the pixel is accordingly expressed as Equation (1) given below:

$$\begin{matrix}V = {Vp}^{′} - Vcom \\ = \{ Vp - ( Votcom - Vcom ) \} - Vcom \\ = Vp - Votcom\end{matrix} \qquad ( 1 )$$

The corrected pixel electrode voltage Vp′ is applied to the pixel electrode 144, while the opposed electrode voltage is fixed to Vcom. The voltage V actually applied to the pixel is thus equivalent to application of the original pixel electrode voltage Vp to the pixel electrode 144 and application of the optimum value Votcom as the opposed electrode voltage. This arrangement sets the mean voltage actually applied to the pixel equal to 0 V and causes no application of a DC offset, thereby preventing a burn-in of the image plane.

The procedure discussed above specifies the difference ΔVcom between the optimum value Votcom and the actual value Vcom of the opposed electrode voltage as an offset and adds the specified offset to the pixel electrode voltage Vp to correct the pixel electrode voltage and thereby prevent a burn-in of the image plane. The procedure of the embodiment shown in FIG. 2 adds a desired digital value as an offset to an input digital image signal, so as to correct the digital image signal.

C. Structure and Operations of Burn-in Prevention Circuit

As shown in FIG. 2, the burn-in prevention circuit 300 of the embodiment includes a tone correction lookup table (hereafter referred to as LUT) 310, an adder-subtracter circuit 320, an in-plane correction arithmetic circuit 330, an in-plane correction memory 335, an adder-subtracter circuit 340, and a DA converter 350 with AC (alternating current) actuation functions. The opposed electrode voltage Vcom described above is input into the liquid crystal panel 400.

The tone correction LUT 310, the in-plane correction arithmetic circuit 330, and the in-plane correction memory 335 in combination correspond to the offset output module of the present invention. The adder-subtracter circuits 320 and 340 correspond to the offset adjunction module of the invention, the DA converter 350 with AC actuation functions corresponds to the alternating current actuation conversion module of the invention. Any of an SRAM, an EEPROM, a flash EEPROM may be applicable for the in-plane correction memory 335.

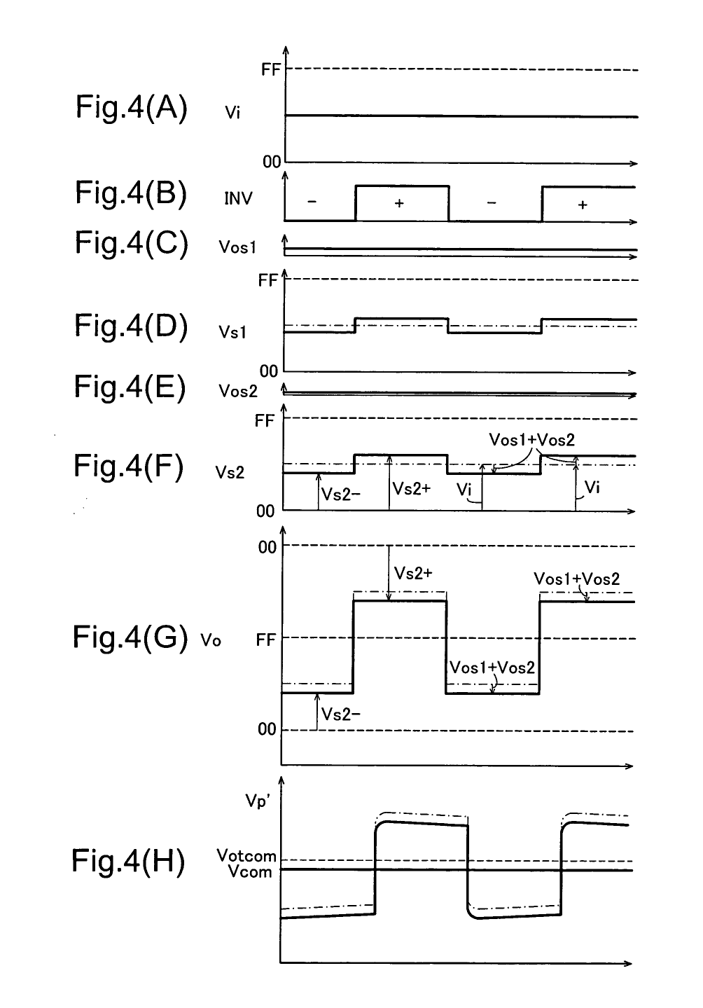

FIGS. 4(A) through 4(H) are timing charts showing variations of essential signals in the burn-in prevention circuit 300 of FIG. 2. FIG. 4(B) shows a variation of a polarity specification signal INV input from the image processing circuit 200. For the simplicity of discussion, a certain pixel on the liquid crystal panel 400 is noted as an object pixel, and variations in signal level in the object pixel are shown in these timing charts, with regard to signals other than the polarity specification signal INV. FIGS. 4(A), 4(C), 4(D), 4(E), 4(F), and 4(G) respectively show variations in signal level in the object pixel with regard to a digital image signal Vi input from the image processing circuit 200, an offset Vos1 output from the tone correction LUT 310, a digital image signal Vs1 output from the adder-subtracter circuit 320, an offset Vos2 output from the in-plane correction arithmetic circuit 330, a digital image signal Vs2 output from the adder-subtracter circuit 340, and an analog image signal Vo output from the DA converter 350 with AC actuation functions. FIG. 4(H) shows a variation in pixel electrode voltage Vp′ supplied to the pixel electrode 144 in the object pixel.

As described above, the digital image signal Vi processed by the image processing circuit 200 enters the burn-in prevention circuit 300. More specifically the digital image signal Vi is input into the tone correction LUT 310 and the adder-subtracter circuit 320. For example, it is assumed that the digital image signal Vi is an 8-bit signal and has 256 tones in a range of ‘00’ to ‘FF’ in hexadecimal notation and that the signal level or tone level of the digital image signal Vi in the object pixel is neither a zero tone level ‘00’ nor a full tone level ‘FF’ but is fixed to an intermediate tone level as shown in FIG. 4(A).

The burn-in prevention circuit 300 receives the polarity specification signal INV and a positioning signal POS (described later), in addition to the digital image signal Vi, from the image processing circuit 200. The polarity specification signal INV is input into the adder-subtracter circuits 320 and 340 and into the DA converter 350 with AC actuation functions. The polarity specification signal INV specifies either a positive polarity (+) or a negative polarity (−) at each frame scanning period for the AC actuation and is generated in the image processing circuit 200 in response to the display clock. The AC actuation inverts the polarity of the pixel electrode voltage relative to the opposed electrode voltage, for example, at each frame scanning period.

An offset, which is equivalent to the difference between the optimum value of the opposed electrode voltage and the actual value of the opposed electrode voltage, at each tone level of the digital image signal has been stored in advance as a digital value in the tone correction LUT 310. When the digital image signal Vi has 256 tones, 256 offset data have been stored in the tone correction LUT 310. The offset stored in the tone correction LUT 310 may take a positive value or a negative value according to the actual value of the opposed electrode voltage.

The tone correction LUT 310 reads the offset Vos1 corresponding to the tone level of the input digital image signal Vi and outputs the offset Vos1 to the adder-subtracter circuit 320. For example, when the digital image signal Vi in the object pixel has the tone level shown in FIG. 4(A), the tone correction LUT 310 reads and outputs the offset Vos1 corresponding to the tone level of the digital image signal Vi as shown in FIG. 4(C).

The adder-subtracter circuit 320 adds the offset Vos1 output from the tone correction LUT 310 to the input digital image signal Vi according to the polarity of the polarity specification signal INV and outputs the digital image signal Vs1 after correction of the tone level for burn-in prevention. For example, the adder-subtracter circuit 320 subtracts the offset Vos1 shown in FIG. 4C from the digital image signal Vi shown in FIG. 4(A) with regard to the object pixel in the case of the negative polarity of the polarity specification signal INV, while adding the offset Vos1 to the digital image signal Vi in the case of the positive polarity of the polarity specification signal INV. This gives the corrected digital image signal Vs1 shown in FIG. 4(D). The graph of the one-dot chain line in FIG. 4(D) represents a digital image signal without such correction.

The positioning signal POS output from the image processing circuit 200 enters the in-plane correction arithmetic circuit 330. The positioning signal POS represents the display position on the image plane of the liquid crystal panel 400. More specifically the positioning signal POS represents the position of the pixel on the image plane displayed in response to the digital image signal Vi input from the image processing circuit 200 at a certain moment. The positioning signal POS is generated in the image processing circuit 200, based on a reading address for reading the digital image signal from the frame memory.

An offset, which is equivalent to the difference between the optimum value of the opposed electrode voltage and the actual value of the opposed electrode voltage, at the position of each of multiple representative pixels on the image plane of the liquid crystal panel 400 has been stored in advance as a digital value in the in-plane correction memory 335. The offset stored in the in-plane correction memory 335 may take a positive value or a negative value according to the actual value of the opposed electrode voltage.

When the display position or the pixel position specified by the input positioning signal POS corresponds to the position of one of the multiple representative pixels, the in-plane correction arithmetic circuit 330 reads the offset Vos2 corresponding to the specified pixel position from the in-plane correction memory 335 and outputs the offset Vos2 to the adder-subtracter circuit 340. When the display position or the pixel position specified by the input positioning signal POS does not correspond to the position of any of the multiple representative pixels, on the other hand, the in-plane correction arithmetic circuit 330 reads plural offsets corresponding to the positions of plural representative pixels in a neighborhood of the specified pixel position from the in-plane correction memory 335, carries out interpolation with the plural offsets, and outputs a result of the interpolation as the offset Vos2 to the adder-subtracter circuit 340. For example, when the input positioning signal POS represents the position of the object pixel as the display position, the in-plane correction arithmetic circuit 330 reads and outputs the value shown in FIG. 4(E) as the offset Vos2 corresponding to the position of the object pixel.

The adder-subtracter 340 adds the offset Vos2 output from the in-plane correction arithmetic circuit 330 to the corrected digital image signal Vs1 according to the polarity of the polarity specification signal INV and outputs the digital image signal Vs2 after further correction of the pixel position for burn-in prevention. As in the case of the adder-subtracter circuit 320, for example, the adder-subtracter circuit 340 subtracts the offset Vos2 shown in FIG. 4(E) from the corrected digital image signal Vs1 shown in FIG. 4(D) with regard to the object pixel in the case of the negative polarity of the polarity specification signal INV, while adding the offset Vos2 to the corrected digital image signal Vs1 in the case of the positive polarity of the polarity specification signal INV. This gives the corrected digital image signal Vs2 shown in FIG. 4(F).

The digital image signal Vs2 shown in FIG. 4(F) is expressed as Equations (2) given below, where Vs2− represents the value corresponding to the negative polarity and Vs2+ represents the value corresponding to the positive polarity:
Vs2−=Vi−(Vos1+Vos2)
Vs2+=Vi+(Vos1+Vos2) (2)

The graph of the one-dot chain line in FIG. 4(F) represents a digital image signal without such correction.

The DA converter 350 with AC actuation functions receives the digital image signal Vs2 from the adder-subtracter circuit 340, converts the input digital image signal Vs2 into the analog image signal Vo, and outputs the analog image signal Vo. The DA converter 350 with AC actuation functions also carries out the polarity inversion at each frame scanning period according to the polarity of the polarity specification signal INV to convert the digital image signal Vs2 into a signal for AC actuation of the liquid crystal, and outputs the resulting signal as the analog image signal Vo. For example, it is assumed that the digital image signal Vs2 shown in FIG. 4(F) with regard to the object pixel is input from the adder-subtracter circuit 340, in the case of the normally white liquid crystal panel 400. When the polarity specification signal INV has the negative polarity, the DA converter 350 with AC actuation functions gives a value Vs2− corresponding to the negative polarity in a positive direction on the basis of the lower ‘00’, while giving a value Vs2+ corresponding to the positive polarity in a negative direction on the basis of the upper ‘00’ as shown in FIG. 4(G). This attains digital-to-analog conversion and the polarity inversion. The graph of the one-dot chain line in FIG. 4(G) represents an analog image signal without such correction for burn-in prevention.

The level of the whole analog image signal Vo output from the DA converter 350 with AC actuation functions is thus shifted in the voltage-decreasing direction by the offset (Vos1+Vos2), compared with the digital image signal without correction for burn-in prevention (the graph of the one-dot chain line).

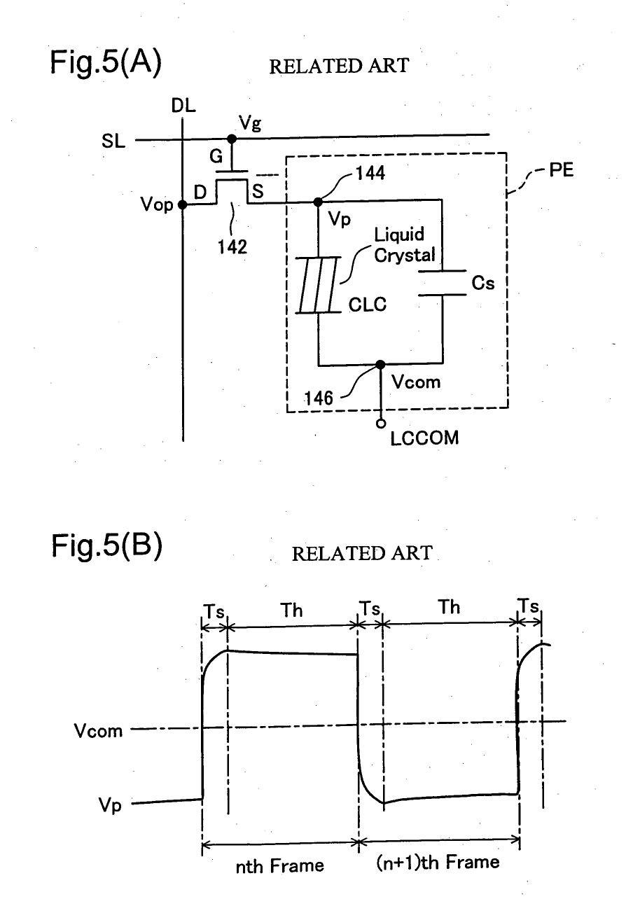

The analog image signal Vo thus obtained enters the liquid crystal panel 400 and is supplied to a signal line DL shown in FIG. 5(A). A pixel signal Vop of the analog image signal Vo corresponding to the object pixel is written as the pixel electrode voltage Vp′ into a pixel capacity Cpe by a TFT switch 142 in a sampling period Ts. The pixel electrode voltage Vp′ is kept in a hold period Th. The corrected pixel electrode voltage Vp′ as shown in FIG. 4(H) is accordingly applied to the pixel electrode 144 in the object pixel. The graph of the one-dot chain line in FIG. 4(H) represents a pixel electrode voltage without such correction.

As discussed in FIG. 3, the corrected pixel electrode voltage Vp′ is applied to the pixel electrode 144, while the opposed electrode voltage is fixed to Vcom. The voltage actually applied to the object pixel is thus equivalent to application of the non-corrected pixel electrode voltage to the pixel electrode 144 and application of the optimum value Votcom as the opposed electrode voltage. This arrangement sets the mean voltage actually applied to the object pixel equal to 0 V and causes no application of a DC offset, thereby preventing a burn-in of the image plane.

The above series of processing for burn-in prevention is carried out with regard to not only the object pixel but all the pixels on the image plane. This effectively prevents a burn-in of the whole image plane on the liquid crystal panel 400.

The processing for burn-in prevention is executed in each of the R, G, and B liquid crystal panels 400R, 400G, and 400B, based on the corresponding offsets by the respective burn-in prevention circuits 300.

D. Method of Detecting Optimum Value of Opposed Electrode Voltage

The method discussed below is adopted to specify the optimum value Votcom of the opposed electrode voltage at each of the varying tone level of the image signal or the optimum value Votcom of the opposed electrode voltage at each of the varying display position or pixel position on the image plane of the liquid crystal panel.

For example, in the case of the varying tone level, the procedure gives an image signal having a certain tone level to the liquid crystal panel 400 and varies the opposed electrode voltage in the liquid crystal panel 400. The procedure then detects a light output from a specified pixel area in the image plane of the liquid crystal panel 400 and sets the opposed electrode voltage having a minimum flicker of the light output to the optimum value Votcom at the certain tone level. The setting of the optimum value Votcom is obtained at each tone level of the image signal.

One example of the optimum value Votcom of the opposed electrode voltage thus obtained is given below. In the R liquid crystal panel, the optimum value Votcom of the opposed electrode voltage is equal to 6.60 V at a tone level corresponding to a luminance 100% and has an increase of +10 mV from the case of the luminance 100% at a tone level corresponding to a luminance 50% and an increase of +70 mV from the case of the luminance 100% at a tone level corresponding to a luminance 0%. In the G liquid crystal panel, the optimum value Votcom of the opposed electrode voltage is equal to 6.48 V at the tone level corresponding to the luminance 100% and has an increase of +30 mV from the case of the luminance 100% at the tone level corresponding to the luminance 50% and an increase of +140 mV from the case of the luminance 100% at the tone level corresponding to the luminance 0%. In the B liquid crystal panel, the optimum value Votcom of the opposed electrode voltage is equal to 6.59 V at the tone level corresponding to the luminance 100% and has an increase of +10 mV from the case of the luminance 100% at the tone level corresponding to the luminance 50% and an increase of +100 mV from the case of the luminance 100% at the tone level corresponding to the luminance 0%.

In the case of the varying pixel position, the procedure gives an image signal having a fixed tone level to the liquid crystal panel 400 and varies the opposed electrode voltage in the liquid crystal panel 400. The procedure then detects a light output from a specified pixel in the image plane of the liquid crystal panel 400 and sets the opposed electrode voltage having a minimum flicker of the light output to the optimum value Votcom at the position of the specified pixel. The setting of the optimum value Votcom is obtained at each pixel position in the image plane.

When there is a difficulty in detecting the light output from one object pixel, the procedure may alternatively detect the light output from a specified pixel area of multiple pixels including the object pixel and peripheral pixels and set the optimum value Votcom of the opposed electrode voltage in each specified pixel area.

E. Modifications

The above embodiment is to be considered in all aspects as illustrative and not restrictive. There may be many modifications, changes, and alterations without departing from the scope or spirit of the main characteristics of the present invention.

In the structure of the embodiment discussed above, the tone correction LUT 310 functions as the offset output module that outputs the offset varying with a variation in tone level of the image signal. When there is a specified relation between the variation in tone level of the image signal and the variation in offset at each tone level, one modified structure stores only offsets corresponding to typical tone levels in an LUT, as in the case of the in-plane correction arithmetic circuit 330 and the in-plane correction memory 335. The structure uses an offset arithmetic circuit to determine the offset corresponding to another tone level by the interpolation technique.

In the structure of the above embodiment, after the adder-subtracter circuits 320 and 340 add the offsets to the image signal, the DA converter 350 with AC actuation functions carries out conversion into the signal allowing for AC actuation of the liquid crystal. This arrangement is, however, not restrictive at all. One modified procedure may carry out conversion into the image signal allowing for AC actuation and add the offsets to the converted image signal.

In the structure of the embodiment, the DA converter 350 with AC actuation functions implements conversion into the signal allowing for AC actuation of the liquid crystal, while carrying out conversion of the digital image signal into an analog image signal. Separate circuits may be provided to carry out the digital to analog conversion and the conversion into the signal for AC actuation.

In the above embodiment, the liquid crystal panels 400 are normally white. The technique of the invention is also applicable to the structure including the liquid crystal panels 400 that are normally black.

In the embodiment discussed above, the technique of the present invention is applied to the three panel-type liquid crystal projector. The technique of the invention is also applicable to two panel-type liquid crystal projectors and four panel-type liquid crystal projectors. In any case, each liquid crystal panel is provided with a burn-in prevention circuit to execute series of processing for burn-in prevention. The invention is especially effective for liquid crystal projectors, but may also be applied to other liquid crystal display devices including both reflection and direct vision types.

The scope and spirit of the present invention are indicated by the appended claims, rather than by the foregoing description.

1. A burn-in prevention circuit that prevents a burn-in of an image plane on a liquid crystal panel, the burn-in prevention circuit comprising:
an offset output module that outputs an offset varying with a variation in tone level of an image signal;
an offset adjunction module that adds at least the offset to the image signal; and
an alternating current actuation conversion module that converts the image signal with the offset added thereto into a specific image signal, which allows for alternating current actuation of liquid crystal at a predetermined cycle,
wherein the specific image signal is supplied to the liquid crystal panel, and
the offset corresponds to a difference between an optimum value of an opposed electrode voltage and an actual value of the opposed electrode voltage at a tone level of the image signal in the liquid crystal panel.

2-5. (canceled)

6. A burn-in prevention circuit in accordance with claim 1, wherein the offset output from the offset output module and the image signal, to which the offset is added by the offset adjunction module, are both digital signals.

7. A burn-in prevention circuit in accordance with claim 6, wherein the offset output module comprises a memory.

8. A burn-in prevention circuit in accordance with claim 6, wherein the alternating current actuation conversion module comprises a digital-to-analog conversion module that converts a digital image signal into an analog image signal.

9. A burn-in prevention circuit that prevents a burn-in of an image plane on a liquid crystal panel, the burn-in prevention circuit comprising:
an offset adjunction module that adds a predetermined offset to an image signal; and
an alternating current actuation conversion module that converts an image signal into a signal, which allows for alternating current actuation of liquid crystal at a predetermined cycle,
wherein a resulting image signal, which includes the offset added thereto and has been converted to allow for the alternating current actuation, is supplied to the liquid crystal panel, and
the offset includes at least one of a first offset corresponding to a difference between an optimum value of an opposed electrode voltage, which varies with a variation in tone level of the image signal in the liquid crystal panel, and an actual value of the opposed electrode voltage, and a second offset corresponding to a difference between an optimum value of the opposed electrode voltage, which varies with a variation in display position or pixel position in the image plane of the liquid crystal panel, and an actual value of the opposed electrode voltage.

10. A projector equipped with a liquid crystal panel, the projector comprising a burn-in prevention circuit in accordance with claim 1.

11-14. (canceled)

15. A projector equipped with a liquid crystal panel, the projector comprising a burn-in prevention circuit in accordance with claim 6.

16. A projector equipped with a liquid crystal panel, the projector comprising a burn-in prevention circuit in accordance with claim 7.

17. A projector equipped with a liquid crystal panel, the projector comprising a burn-in prevention circuit in accordance with claim 8.

18. A projector equipped with a liquid crystal panel, the projector comprising a burn-in prevention circuit in accordance with claim 9.

19. A projector equipped with multiple liquid crystal panels, the projector comprising a burn-in prevention circuit in accordance with claim 1 for each of the multiple liquid crystal panels.

20-23. (canceled)

24. A projector equipped with multiple liquid crystal panels, the projector comprising a burn-in prevention circuit in accordance with claim 6 for each of the multiple liquid crystal panels.

25. A projector equipped with multiple liquid crystal panels, the projector comprising a burn-in prevention circuit in accordance with claim 7 for each of the multiple liquid crystal panels.

26. A projector equipped with multiple liquid crystal panels, the projector comprising a burn-in prevention circuit in accordance with claim 8 for each of the multiple liquid crystal panels.

27. A projector equipped with multiple liquid crystal panels, the projector comprising a burn-in prevention circuit in accordance with claim 9 for each of the multiple liquid crystal panels.

28. A liquid crystal display apparatus, comprising a burn-in prevention circuit in accordance with claim 1.

29-32. (canceled)

33. A liquid crystal display apparatus, comprising a burn-in prevention circuit in accordance with claim 6.

34. A liquid crystal display apparatus, comprising a burn-in prevention circuit in accordance with claim 7.

35. A liquid crystal display apparatus, comprising a burn-in prevention circuit in accordance with claim 8.

36. A liquid crystal display apparatus, comprising a burn-in prevention circuit in accordance with claim 9.

37. A method of preventing a burn-in of an image plane in a liquid crystal panel, the method comprising the steps of:
(a) adding a predetermined offset to an image signal;
(b) converting an image signal into a signal that allows for alternating current actuation of liquid crystal at a predetermined cycle; and
(c) supplying a resulting image signal, which includes the offset added thereto and has been converted to allow for the alternating current actuation, to the liquid crystal panel,
wherein the offset includes at least one of a first offset corresponding to a difference between an optimum value of an opposed electrode voltage, which varies with a variation in tone level of the image signal in the liquid crystal panel, and an actual value of the opposed electrode voltage, and a second offset corresponding to a difference between an optimum value of the opposed electrode voltage, which varies with a variation in display position or pixel position in the image plane of the liquid crystal panel, and an actual value of the opposed electrode voltage.
